(19) United States
(12) Patent Application Publication
(10) Pub. No.: US 2026/0368315 A1
(43) Pub. Date: Nov. 19, 2026

(54) SYSTEM AND METHOD FOR INTELLIGENT PROTECTION CYBER SHIELD MODULE OF A BATTERY ENERGY STORAGE SYSTEM FOR ATTACK DETECTION AND CONTAINMENT

(71) Applicant: FLUENCE ENERGY, LLC, Arlington, VA (US)

(72) Inventors: Mohamamdhassan Abdollahi Sofla, Raleigh, NC (US); Isaiah Dallas Jefferson, JR., Mitchellville, MD (US)

(73) Assignee: FLUENCE ENERGY, LLC, Arlington, VA (US)

(21) Appl. No.: 19/144,244

(22) PCT Filed: Sep. 27, 2024
(86) PCT No.: PCT/US2024/048771

§ 371 Date: Jun. 27, 2025

Related U.S. Application Data
(60) Provisional application No. 63/541,508, filed on Sep. 29, 2023.

(51) Int. Cl. G06F 21/55; G06F 21/81; H01M 10/42

(52) U.S. Cl. CPC G06F 21/554; G06F 21/81; H01M 10/425; G06F 2221/034; H01M 2010/4278; H01M 2220/10

(57) ABSTRACT

A system includes an energy storage system including at least one power conversion system coupled to a plurality of energy storage nodes, at least one control system coupled to the plurality of energy storage elements and the at least one power conversion system, and intelligent protection shield module (“IPSM”) coupled to the energy storage system. The IPSM includes a processor that detects abnormalities when observed patterns match any abnormal activity patterns or when governing logics of the energy storage system are violated, and executes containment of the energy storage system when abnormalities are detected.

### CROSS-REFERENCE TO RELATED APPLICATIONS

This application claims priority to U.S. Patent Application No. 63/541,508 filed on Sep. 29, 2023, titled “System and Method for Intelligent Cyber Shield Module of a Battery Energy Storage System for Attack Detection and Containment,” the entire disclosure of which is incorporated by reference herein.

### TECHNICAL FIELD

The present subject matter relates to systems and methods for cyberattack detection and containment a battery energy storage system (BESS).

### BACKGROUND

Battery energy storage systems, compound energy storage systems, as well as some energy provisioning systems, are often critical infrastructure which may be subject to cyberattack. Cyberattacks can be used to reduce or eliminate electrical output, or cause damage to the energy provisioning system. If the energy provisioning system is substantial enough, a cyberattack can utilize the energy provisioning system to attack the entire electrical grid, possibly by destabilizing the grid frequency and consequently disabling the electrical grid.

The threat of cyberattack, or threat of malicious use of the energy provisioning system after a successful cyberattack yields control of the energy provisioning system, can result in extortion attempts, either extract resources or benefits from the owner of the energy storage system, or from owners or users of the connected electrical grid, such as companies, civilians, and governments.

Proper cyberattack prevention requires robust cyber security. In some conventional energy provisioning system implementations, network cyber security firewall and cyberattack prevention methods are relied upon. However, all these cyber security systems are not completely flawless. Furthermore, these cyber security systems tend to be reactive, and often are updated with new detection mechanisms only after an attack has already taken place.

Energy provisioning system assets are very critical, and if a cyberattack is intruded the cyberattack will impact the availability of sites, customer confidence and may result in costly failures. Furthermore, some of the failures in the energy provisioning system can lead to cascaded failures in which the consequences may impact the electrical grid and shutdown part or all the electric grid.

Hence, there is a need for systems and methods for an intelligent cyber shield energy storage system module for attack detection and containment.

### SUMMARY

In a first example, a system 100 includes an energy storage system 101 including at least one power conversion system 104 coupled to a plurality of energy storage elements 105A-N, at least one control system 115 coupled to the plurality of energy storage elements 105A-N and the power conversion system 104, and an intelligent protection shield module (“IPSM”) 502 coupled to the energy storage system 101 and including a processor 312, 352. The IPSM 502 is configured to: detect abnormalities when observed patterns match any abnormal activity patterns 118A-N or when governing logics 119A-N of the energy storage system 101 are violated; and execute containment of the energy storage system 101 when abnormalities are detected.

In a second example, a method includes detecting abnormalities of an energy storage system 101 when observed patterns of the energy storage system 101 match any abnormal activity patterns 118A-N or when governing logics 119A-N of the energy storage system 101 are violated; and executing containment of the energy storage system 101 when abnormalities are detected.

In a third example, a non-transitory computer-readable medium 313 includes an intelligent protection shield module (“IPSM”) 502. Execution of the IPSM 502 by one or more processors 312 configures one or more computing devices to: detect abnormalities when observed patterns of the energy storage system 101 match any abnormal activity patterns 118A-N or when governing logics 119A-N of the energy storage system 101 are violated; and execute containment of the energy storage system 101 when abnormalities are detected.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1 depicts a system that includes an energy storage system, an energy system, and an electrical application, according to embodiments of the present disclosure.

FIG. 2 illustrates a first energy storage node of a plurality of energy storage nodes of the energy storage system of FIG. 1 coupled to the electrical application.

FIG. 3 is a cutaway view of the first energy storage node of the plurality of energy storage nodes and shows details of a plurality of battery storage elements.

FIG. 4 is a high-level functional block diagram of the energy storage system of FIG. 1 that depicts components of the control system and the energy storage nodes for cyberattack detection and containment in a battery energy storage system.

FIG. 5 is a diagram depicting an intelligent protection shield module (“IPSM”) in energy storage systems.

FIG. 6 is a diagram depicting the process control algorithm of the intelligent protection shield module (“IPSM”) in energy storage systems.

### PARTS LISTING

| | |
|---|---|
| 100 | System |
| 101 | Energy Storage System |
| 102 | Energy System |
| 103 | Electrical Application |
| 104 | Power Conversion System |
| 105A-N | Energy Storage Nodes |
| 106, 106A-N | Battery Storage Elements |
| 107 | Power Conversion Subsystem |
| 108 | Transformer |
| 109 | Energy Source |
| 110 | Control Subsystem |
| 111A-N | Electrical Data |
| 112A-N | Normal Activity Patterns |
| 115 | Control System |
| 116A-N | Battery Data |
| 117A-N | Expected or Predetermined Values or Ranges |
| 118A-N | Abnormal Activity Patterns |
| 119A-N | Governing Logics |
| 120 | Physical Space |
| 125 | Power Bus |
| 205 | Power Inverter |
| 210 | Rectifier |
| 215 | DC-DC Converter |
| 300 | Enclosure |
| 305, 305A-N | Network |
| 311, 351 | Network Communication Interface |
| 312, 352 | Processor |
| 313, 353 | Memory |
| 315A-N | Sensors |
| 330A-B | Intelligent Protection Shield Module |
| | (“IPSM”) Control Programming |
| 370A-N | Environmental Sensors |
| 502 | Intelligent Protection Shield Module |
| | (“IPSM”) Module |
| 614 | User Interface |
| 600 | Process Flow |

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, transfer functions, and/or circuitry have been described at a relatively high-level, without detail, in order to avoid unnecessarily obscuring aspects of the present teachings.

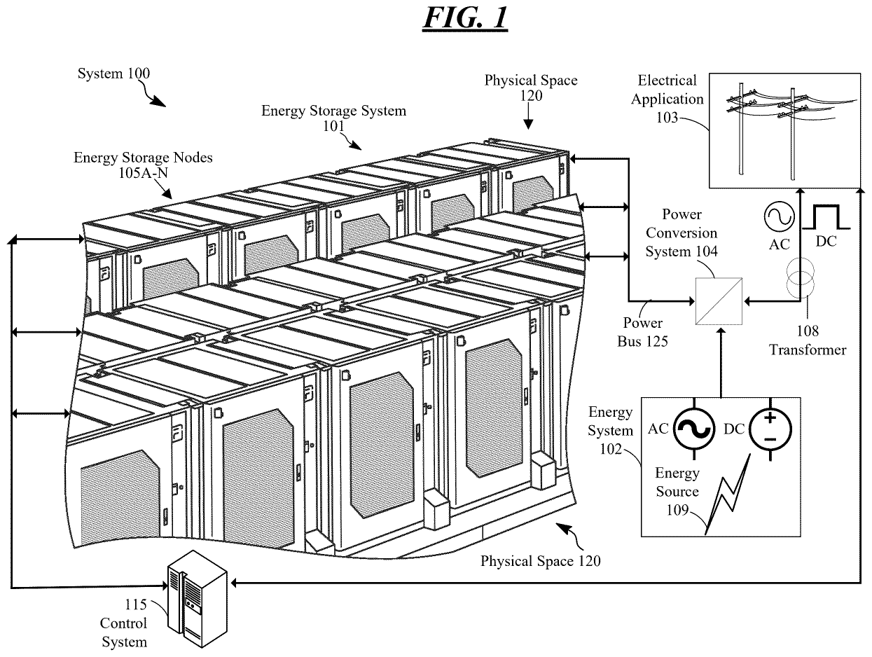

Unless otherwise indicated, any embodiment can be combined with any other embodiment. In particular, FIGS. 1-6 and the associated text are all combinable with each other.

The term “coupled” as used herein refers to any logical, physical, electrical, or optical connection, link or the like by which signals or light produced or supplied by one system element are imparted to another coupled element. Unless described otherwise, coupled elements or devices are not necessarily directly connected to one another and may be separated by intermediate components, elements, or communication media that may modify, manipulate, or carry the light or signals.

The orientations of the system 100, energy storage system 101, energy storage nodes 105A-N, associated components, and/or any complete devices, incorporating battery storage elements 106A-N, such as batteries, such as shown in any of the drawings, are given by way of example only, for illustration and discussion purposes. In operation for a particular energy storage application, an energy storage node 105A-N may be oriented in any other direction suitable to the particular application of the energy storage system 101, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any energy storage system 101 or energy storage nodes 105A-N; or component of an energy storage system 101 or energy storage nodes 105A-N constructed as otherwise described herein.

Unless otherwise indicated, any multiplicity of components, such as energy storage nodes 105A-N or battery storage elements 106A-N can include any number of said components, including as few as one, and are not limited by the depicted number of components. Unless otherwise indicated, any coupled electrical components can be linked in series or in parallel. In the case of energy storage nodes 105A-N or battery storage elements 106A-N, the components may be linked in series, in parallel, or a combination thereof depending upon a state of a switch or a submodule.

Cybersecurity is based upon three primary categories: encryption, access control, and integrity. The intelligent cyber shield technologies disclosed herein are based on the integrity element of cybersecurity.

The intelligent cyber shield technologies disclosed herein employ a machine learning algorithm based on signal processing to detect cyberattacks.

The intelligent cyber shield technologies disclosed herein processes battery energy storage systems (BESS) signals to check for the integrity security element of the BESS. After detecting an abnormal activity pattern, the intelligent cyber shield technologies promptly notify a service team via a user interface (UI) which includes a full report of the exact activity.

Furthermore, the intelligent cyber shield technologies disclosed herein include a multi-layer feature of containing an attack. The multi-layer containment (e.g., remedial action) feature detects the severity of any abnormality (e.g., intrusion in the system) and prevents failures and unwanted behaviors that the cyberattack intends.

Additionally, the intelligent cyber shield technologies disclosed herein include a machine learning feature that can learn if a service team labels a detected behavior as safe, and consequently update the future detection process.

The improvements to the intelligent cyber shield technologies disclosed herein can increase the availability of a BESS in the event of a cyberattack, and can also mitigate costly failures caused by cyberattacks.

Reference now is made in detail to the examples illustrated in the accompanying drawings and discussed below.

FIG. 1 depicts a system 100 that includes an energy storage system 101, energy system 102, and an electrical application 103. For example, the energy storage system 101 can be a battery energy storage system (BESS). The energy storage system 101 is coupled to the energy system 102 and the electrical application 103. Energy storage system 101 can include a power conversion system 104, a plurality of energy storage nodes 105A-N, an optional transformer 108, and a control system 115. Components of the energy storage system 101 can be located at a physical space 120 that is outdoors or indoors, for example, inside of a building, a container, or other structure.

Power conversion system 104 is coupled to the plurality of energy storage nodes 105A-N. The power conversion system 104 is coupled to the energy system 102 and the electrical application 103 to provide a required power flow to the electrical application 103 by discharging the plurality of energy storage nodes 105A-N or the required power flow from the energy system 102 for charging the plurality of energy storage nodes 105A-N. The power conversion system 104 can be coupled to an optional transformer 108. The optional transformer 108 can step up or step down the required power flow to and from the electrical application 103, such as an AC voltage. The power conversion system 104 is configured to standardize power inputs and outputs to and from the energy storage nodes 105A-N.

Energy system 102 can include any suitable system for producing electrical energy from an energy source 109. Energy system 102 can be a renewable energy system in which the energy source 109 can be replenished. Such a renewable energy source 109 can include solar power, wind power, geothermal power, biomass, and hydroelectric power. For example, the renewable energy system 102 can be implemented as an array of photovoltaic modules. The photovoltaic (PV) modules can include crystalline silicon, amorphous silicon, copper indium gallium selenide (CIGS) thin film, cadmium telluride (CdTe) thin film, and concentrating photovoltaic which uses lenses and curved mirrors to focus sunlight onto small, but highly efficient, multi-junction solar cells. In another example, the energy system 102 can include wind turbines or gas turbines. In some examples, the energy system 102 can be a non-renewable energy system in which the energy source 109 includes a non-renewable energy source, such as a fossil fuel.

Electrical application 103 can include an electrical grid, such as a power grid, or a smaller local load, such as a backup power system, for a facility such as a hospital, manufacturing site, residential home, or other suitable facility. The electrical application 103 may deliver AC or DC power for on-grid or off-grid applications, including commercial, industrial, or residential applications. The electrical application 103 may deliver power to buildings, electric vehicle charging stations, etc., including a variety of electrical loads that consume AC or DC electric power. The electrical application 103 can be a front-of-the-meter system that is owned or operated by a utility company or a behind-the-meter system that directly supplies buildings and homes with electricity.

Energy source 109 can be a renewable energy source, such as solar power and wind power, which can be intermittent and less reliable compared to fossil fuels. To improve resiliency, energy storage system 101 can store energy from the energy system 102 when the production from the energy source 109 is high. Later on, the energy storage system 101 can dispatch the energy to the electrical application 103 when demand is high or production from the energy source 109 is not keeping up with demand. Moreover, events may occur when a connected load or an operating demand load of the electrical application 103 is excessive or there is electrical grid instability, such as during extreme weather. By storing energy from the energy source 109 and then dispatching the energy during such events, the energy storage system 101 can continue to dispatch a required power flow of the electrical application 103.

Energy storage nodes 105A-N include battery storage elements 106A-N. The battery storage elements 106A-N can be: (1) a single battery cell; (2) a cell grouping, including several battery cells in parallel configuration; (3) a battery submodule or module, including several battery cells in parallel and serial configuration; (4) a battery string, including several battery modules in series; (5) a battery bank, including several battery strings in parallel; (6) other known energy storage elements; and/or (7) a combination thereof. For example, the battery storage elements 106A-N can include a plurality of batteries of any existing or future reusable battery technology that can be used in a battery energy storage system (BESS), including, but not limited to, lithium ion or flow batteries, or mechanical storage, such as flywheel energy storage, compressed air energy storage, pumped-storage hydroelectricity, gravitational potential energy, or a hydraulic accumulator, for example.

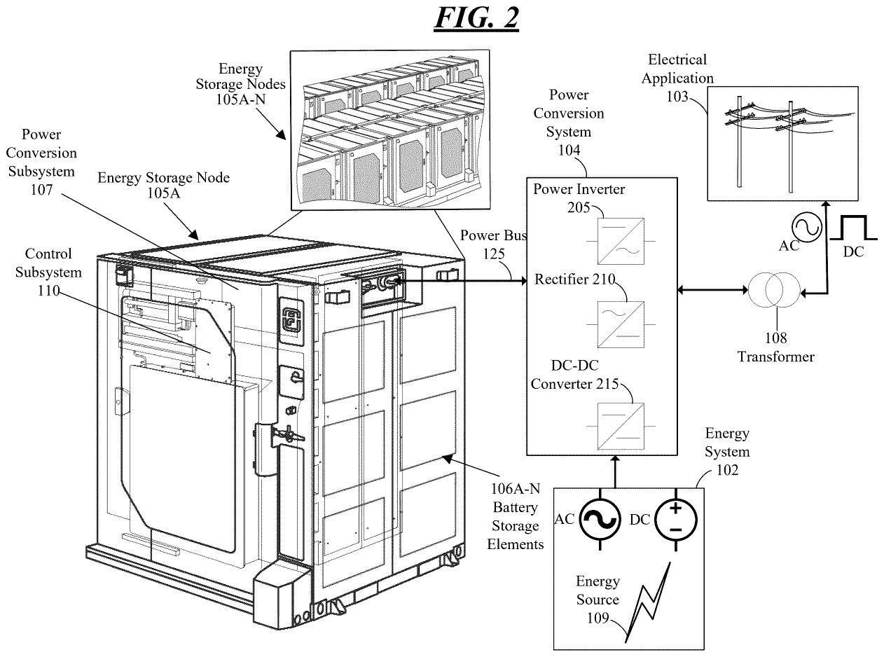

FIG. 2 illustrates a first energy storage node 105A of the plurality of energy storage nodes 105A-N of FIG. 1 coupled to the electrical application 103. Energy storage nodes 105A-N can include a battery storage element 106, a power conversion subsystem 107, and a control subsystem 110, or a combination thereof. Energy storage system 101 can be controlled such that the electrical application 103 is fulfilled while distributing the dispatch of required power flow across the plurality of battery storage elements 106A-N according to awareness of the control system 115 relating to certain battery conditions, including a state of charge, a temperature, and other physical phenomena occurring within the battery storage elements 106A-N.

Power conversion system 104 can include a power inverter 205, a rectifier 210, a DC-DC converter 215, other power conversion elements, or a combination thereof. Power inverter 205 can be configured to convert a DC source, such as from the battery storage elements 106A-N, into an AC waveform. Rectifier 210 can be configured to convert an AC source, such as from the energy system 102 or electrical application 103, into DC for the battery storage elements 106A-N. DC-DC converter 215 can be configured to convert a DC source, such as from the battery storage elements 106A-N, into a different DC source characteristic.

If the energy source 109 is wind power, then the power conversion system 104 can convert the AC electricity produced into DC power for storage in the plurality of energy storage nodes 105A-N via the rectifier 210. If the energy source 109 is solar power, then the power conversion system 104 can convert the DC electricity into a different voltage level via the DC-DC converter 215. The power inverter 205 can convert the required power flow from the energy storage system 101 from DC power into AC power during dispatch to the electrical application 103. For example, the power inverter 205 can be configured to convert power on a power bus 125 for use by the electrical application 103. For example, the power inverter 205 converts DC power stored in the energy storage nodes 105A-N into AC power for consumption by electrical loads of the electrical application 103.

Power conversion subsystem 107 includes similar hardware and software as the more centralized power conversion system 104. Power conversion subsystem 107 is distributed more locally to each of energy storage nodes 105A-N. The control subsystem 110 can be configured for local computation, processing, and control of the battery storage elements 106A-N and the power conversion subsystem 107. The control system 115 can be configured for more centralized computation, processing, and controls of the overall energy storage system 101, energy system 102, electrical application 103, and power conversion system 104. Both the control subsystem 110 and control system 115 can include a single board computer, an application-specific integrated circuit (ASIC), microcontroller, digital signal processor (DSP), field-programmable gate array (FPGA), or a combination thereof.

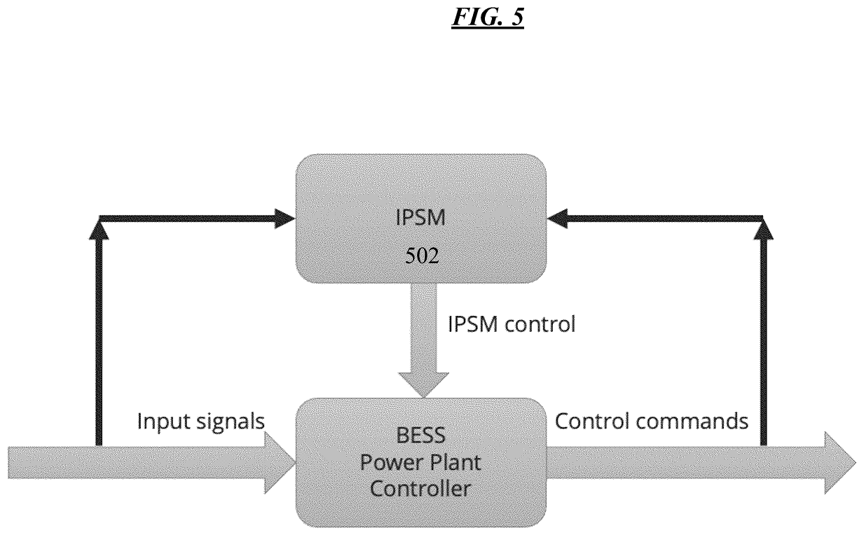

The control system 115 and the control subsystem 110 may interface with or include an intelligent protection shield module (“IPSM”) module 502 (see FIG. 5).

Physical data collection sensors and data logging can be used throughout the energy storage system 101, to collect operational and environmental data from the components of the energy storage system 101, such as the energy storage nodes 105A-N, PCSs, battery management systems (BMSs), apparent power system controllers (APSs), node storage dispatch units (SDUs), core SDUs, and real-time automation controllers (RTACs). The collected data can include, but is not limited to, state of charge (SOC), power, differential voltages, or temperature of the energy storage nodes, PCSs, BMSs, APSs, node SDUs, core SDUs, or RTAC.

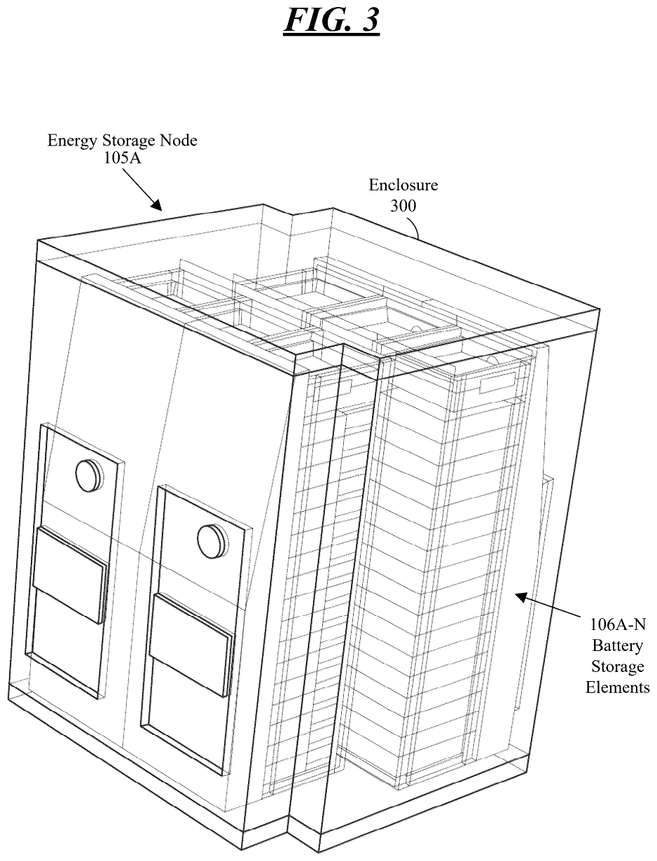

FIG. 3 is a cutaway view of the first energy storage node 105A of the plurality of energy storage nodes 105A-N and shows details of a plurality of battery storage elements 106A-N. As shown, the energy storage node 105A includes an enclosure 300, such as a physical housing to store a plurality of battery storage elements 106A-N. The battery storage elements 106A-N can be a collection of one or more batteries, such as a plurality of battery strings or battery banks, which are organized logically, physically, and electrically.

In the example of FIG. 3, the battery storage elements 106A-N can include battery racks (e.g., six are shown) that hold a respective stack of battery modules (e.g., seventeen are shown). The battery modules can include an array of prismatic, pouch, or cylindrical battery cells that are packaged together to increase voltage, amperage, or both. In some examples, battery modules may include an electric vehicle battery pack, e.g., a collection of lithium-ion battery cells that are packaged together.

The energy storage nodes 105A-N may resemble the features presented in the energy storage system described in International Application No. PCT/US2021/30551, filed on May 4, 2021, titled “Energy Storage System with Removable, Adjustable, and Lightweight Plenums,” the entirety of which is incorporated by reference herein.

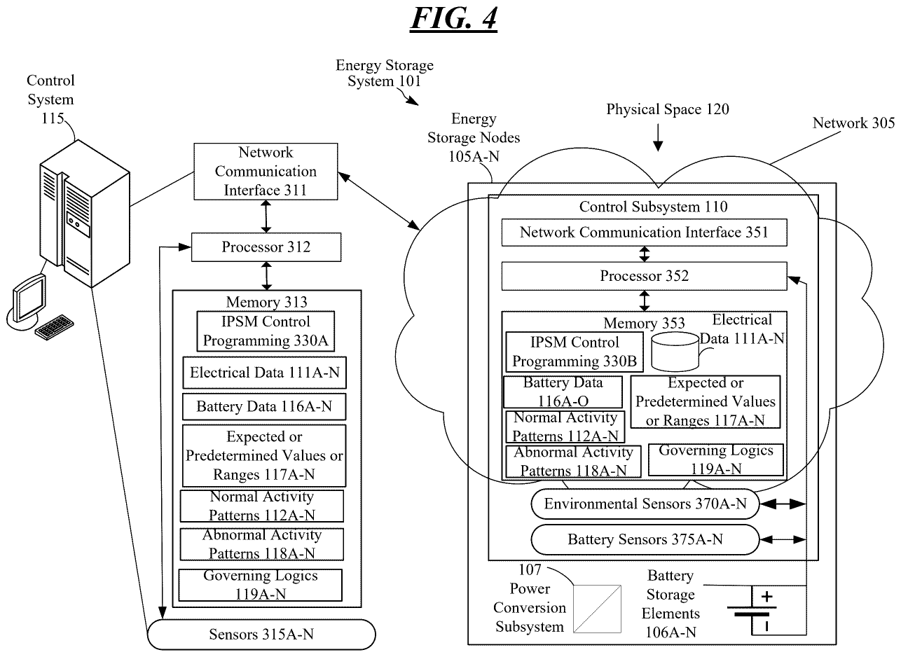

FIG. 4 is a high-level functional block diagram of the energy storage system 101 of FIG. 1 that depicts components of the control system 115 and the energy storage nodes 105A-N to detect abnormalities (e.g., intrusions in the system) of the energy storage system 101 based on control signals of the energy storage system 101, and execute containment (e.g., remedial action) of the energy storage system 101 when abnormalities are detected. As shown, the plurality of energy storage nodes 105A-N include a battery storage element 106A-N, a power conversion subsystem 107, and a control subsystem 110 configured to receive battery data 116A-N and electrical data 111A-N from the battery storage element 106A-N, the power conversion subsystem 107, or a combination thereof.

The control signals of the energy storage system 101 can include, but are not limited to, operational data or electrical data 111A-N, such as current, voltage, power, charge or discharge instructions or commands, power pulse patterns during charging or discharging (e.g., activity pattern), apparent power or real time power (e.g., activity pattern) from the battery storage element 106A-N, the power conversion subsystem 107, or a combination thereof, and battery data 116A-N, such as battery voltage, battery current, battery temperature, battery state of charge (SOC), or other physical phenomena occurring within the battery storage elements 106A-N, and/or environmental data, in particular voltage, current, temperature, or state of charge from the components of the battery energy storage system, such as the power input and output of PCSs or battery management systems (BMSs), which, along with the PCSs, communicate with apparent power system controllers (APSs), full operating system (FOS) control signals, as well as feedback and statuses from a battery management system (BMS), the battery storage element 106A-N, power conversion system (PCS) 104, and meter subsystems. The APSs and the BMSs communicate with node storage dispatch units (SDUs). Node SDUs interface with and monitor the connected BMSs, PCSs and other hardware to higher level controls. The electrical data 111A-N can also include at least one of current and voltage or power output of the power conversion system 104.

The control system 115, energy storage nodes 105A-N, electrical application 103, and other components of the system 100 can be in communication over a network 305 or one or more networks 305A-N. The networks 305A-N can be a local area network 305A, wide area network 305B, or a combination thereof. For example, the control system 115 can be coupled via a local area network 305A to the energy storage nodes 105A-N and the electrical application 103. Alternative or additionally, the control system 115 can be coupled via a wide area network 305B to the energy storage nodes 105A-N and electrical application 103. Or the control system 115 can be coupled via a combination of networks 305A-N, such as via a local area network 305A to components of the energy storage system 101, including the energy storage nodes 105A-N, and coupled via a wide area network 305B to the electrical application 103.

Control system 115 includes a network communication interface 311 configured for wired or wireless communication over the network 305. The control system 115 further includes a memory 313, and a processor 312 coupled to the network communication interface 311 and the memory 313. As shown, the memory 313 of the control system 115 is configured to store an intelligent protection shield module (“IPSM”) control programming 330A, electrical data 111A-N, and battery data 116A-N. The control system 115 can also include sensors 315A-N coupled to the processor 312 to detect or monitor various system parameters, such as power, temperature, voltage, current, resistance, and/or impedance. For example, the sensors 315A-N can be coupled to the power bus 125.

Control system 115 is configured to store, e.g., in memory 313, expected or predetermined values or ranges 117A-N for the battery data 116A-N and electrical data 111A-N from the battery storage element 106A-N, the power conversion subsystem 107, or a combination thereof, as well as a set of normal activity patterns 112A-N, a set of abnormal activity patterns 118A-N created through simulated harmful scenarios, and a set of governing logics 119A-N for energy storage system 101. Based on the result of the comparison of the values of the received battery data 116A-N and electrical data 111A-N from the battery storage element 106A-N, the power conversion subsystem 107, or a combination thereof, with the stored expected or predetermined values or ranges 117A-N for the battery data 116A-N and electrical data 111A-N, and/or of the monitored activity patterns of the energy storage system 101 with the set of normal activity patterns 112A-N and the set of abnormal activity patterns 118A-N, the control system 115 can detect abnormalities, based on the monitored control signals, when the observed patterns match any abnormal activity patterns 118A-N or when the governing logics 119A-N of the energy storage system 101 are violated, as described further below. In the context of the present disclosure, abnormalities relate to intrusions in the energy storage system 101 evidenced by, for example, deviations or discrepancies from the expected behavior of the energy storage system 101, including but not limited to out of expected range values for measured parameters, malfunctioning of components, generation of errors or warnings, or any other unexpected behavior of the energy storage system 101.

Energy storage nodes 105A-N include a control subsystem 110, battery storage elements 106A-N, and a power conversion subsystem 107. Control subsystem 110 of the energy storage nodes 105A-N includes a network communication interface 351 configured for wired or wireless communication over the network 305. The control subsystem 110 further includes a memory 353, and a processor 352 coupled to the network communication interface 351 and the memory 353. As shown, the memory 353 of the control subsystem 110 can be configured to store an intelligent protection shield module (“IPSM”) control programming 330B, battery data 116A-N and electrical data 111A-N from the battery storage element 106A-N, the power conversion subsystem 107, or a combination thereof, expected or predetermined values or ranges 117A-N for the battery data 116A-N and electrical data 111A-N, a set of normal activity patterns 112A-N, a set of abnormal activity patterns 118A-N, and a set of governing logics 119A-N.

The control subsystem 110 can further include environmental sensors 370A-N coupled to the processor 352. Environmental sensors 370A-N can measure humidity and temperature inside of an enclosure 300 of the energy storage nodes 105A-N.

FIG. 5 is a diagram depicting the intelligent protection shield module (“IPSM”) 502 in an energy storage system 101. The intelligent protection shield module 502 has access to the control system 115 and the control subsystem 110, and to all levels of data generated via the control system 115 and the control subsystem 110. The intelligent protection shield module 502 provides a protection layer based on ensuring the integrity of the control signals of the energy storage system 101. This protection layer addresses any abnormality (e.g., intrusion in the system) that could cause abnormal behavior in the energy storage system 101. Abnormalities can have different sources, such as physical failures of components or cyber manipulation of data, for example. Regardless, these abnormalities and any resulting abnormal signals can cause abnormal behavior of the energy storage system 101, which can then cause major damage to the energy storage system 101 equipment, as well as cause major misoperation on the electrical application 103 (e.g., an electrical grid). For example, an abnormal sensing signal can cause the energy storage system 101 to impact the frequency or voltage of the electrical application 103 in an undesired way, and cause major adverse impact.

In addition, the IPSM 502 can address the integrity gap found in the cybersecurity of some energy storage control systems (considering that cybersecurity is built on three primary categories: encryption, access control, and integrity). To address this gap, artificial intelligence (“AI”)-based algorithms, such as neural networks, for example, can be utilized to detect potential attack patterns. For example, the IPSM 502 can employ a machine learning algorithm based on signal processing to detect cyberattacks. The IPSM 502 can train a machine learning model based on the expected inputs. For example, for energy provisioning system assets with frequency control, if an asset is discharging based on frequency, the IPSM 502 can consider this situation an abnormal pattern.

In an exemplary embodiment, the IPSM 502 can have three parts: 1) pattern detection, 2) governing logics monitoring; and 3) control containment (e.g., remedial action) in case of abnormalities. A set of normal activity patterns 112A-N can be generated by analyzing the existing systems of the energy storage system 101, while a set of abnormal activity patterns 118A-N can be created, e.g., in advance, through simulated harmful scenarios. The set of abnormal activity patterns 118A-N can be stored in the memory 313 of the control system 115, for example. In addition to the set of normal activity patterns 119A-N, a set of governing logics 119A-N for energy storage system 101 can be developed and stored in the memory 313 of the control system 115. These governing logics 119A-N can be derived from the physics, architecture and power flow of the entire energy storage system 101. For example, the metering of the electrical output of the energy storage system 101 at the point of interconnection with the electrical application 103 should be almost the same as sum of the output of the power conversion systems 104 in the energy storage system 101. Given this example, the following equation is an example of a governing logic 119A-N for an energy storage system 101 with n energy storage nodes 105A-N:

$${\sum }_{i}^{n} {P}_{i} \geq {P}_{PIC} \geq {\sum }_{i}^{n} α {P}_{i} , 0 < α < 1$$

where P_{PIC} is the power at point of interconnection of the energy storage system 101 with the electrical application 103 (e.g., an electrical grid). Pᵢ is the output power of power conversion (PCS) 104, i is a number associated with each corresponding power conversion system 104 of the power conversion systems 104, and the summation index n indicates the number of PCS 104 units in the energy storage system 101. Coefficient α is a tuning parameter for the machine learning model described below. Coefficient α adjusts for the losses in the energy storage system 101 and can be configured based on architecture and configuration of a given energy storage system 101. For example, if α=0.9, it means it is expected to have maximum of 10% energy loss in the energy storage system 101. This governing logic or equation means that if the electrical power output in the metering does not match the sum of electrical power outputs of PCSs 104 and the electrical power loss, then the power flow law is violated and there is an abnormality (e.g., intrusion in the system). This abnormality can be anything from failed metering at the point of interconnection to the electrical application 103 (e.g., an electrical grid) or a cyber manipulation of power feedback P_{PIC}. The equation described above is only one example of the governing logics 119A-N that the IPSM 502 can deploy for detection of abnormalities.

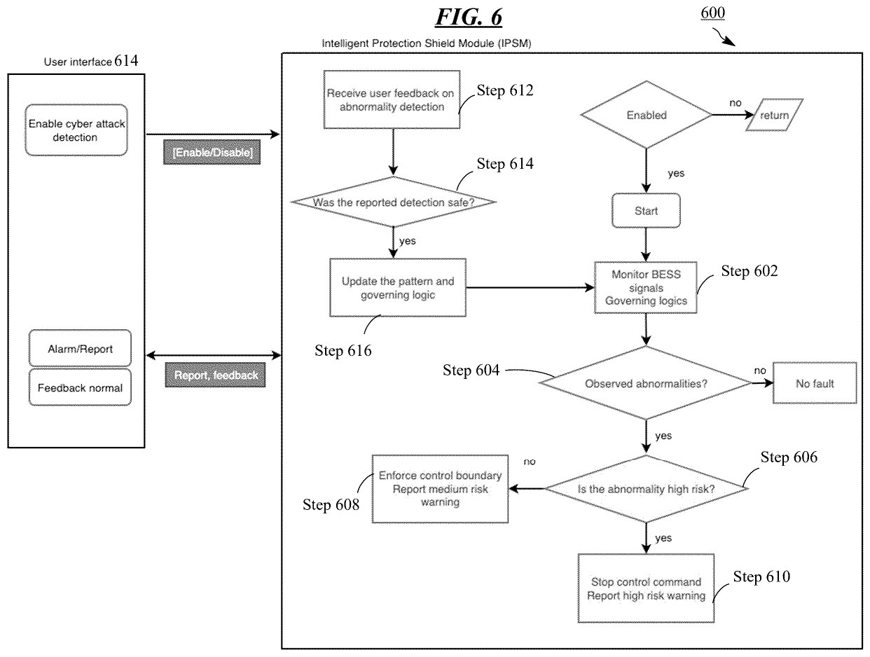

FIG. 6 illustrates a process flow 600 of an algorithm controlling the operation of the IPSM 502. A user interface (UI) 514 of the full operating system (FOS), which operates the energy storage system 101, is configured to enable or disable the cyberattack detection feature of the IPSM 502. If enabled, the IPSM 502 process starts, and a multi-layer containment (e.g., remedial action) feature operates in real-time, continuously monitoring control signals and identifying any abnormalities (step 602). For example, the IPSM 502 gathers data (e.g., control signals from the energy storage system 101), compares the gathered data with the expected or predetermined values and ranges 117A-N (FIG. 4) of the control signals saved in the memory of the control system 115 or the control subsystem 110 and/or the monitored activity patterns of the energy storage system 101 to the set of abnormal activity patterns 118A-N based on calculations using, e.g., the governing logic described above, and detects abnormalities, based on the results of the comparison (step 604). When abnormalities are detected at a medium risk level (step 606, path No), the IPSM 502 executes a medium-risk remedial action, such as promptly alerting a service team, and establishing a boundary for control signals (step 608), for example. In the case of high-risk intrusions (step 606, path Yes), the IPSM 502 executes a high-risk remedial action, such as raising a high-risk alarm or warning (step 610) and, optionally, stopping the control commands, for example.

The intelligent protection shield module IPSM 502 swiftly detects abnormalities, alerts the service team to take necessary action, and establishes emergency boundary layers on control commands based on the level of risk, thus mitigating the potential for significant malfunctions.

The intelligent protection shield module (IPSM) 502 can be enabled by the full operating system (FOS) which operates the energy storage system 101. Once enabled, the IPSM 502 monitors control signals, and determines whether the observed activity pattern matches any of the abnormal activity patterns 118A-N stored in the memory 313 of the control system 115 and/or in the memory 353 of the control subsystem 110, or if the governing logics 119A-N of the energy storage system 101 are violated. If the result of these determinations is negative, then no fault is found. If a match is found, the observed abnormality is compared to high risk abnormal levels and patterns. If no match is found during this comparison, then the observed abnormality is matched to a medium risk abnormal pattern, a tight control boundary is instantiated, and a medium risk warning is reported. If a match is found during this comparison, then due to the match with a high-risk abnormal pattern, a high-risk warning is reported and, optionally, a stop on the operation the energy storage system 101 can be instantiated. If the risk warning is investigated and no cyberattack is identified (steps 612, 614 in FIG. 6), the pattern is proved normal or safe, and the set of normal activity patterns 119A-N is updated to include the observed pattern (step 616).

In certain embodiments, the set of normal activity patterns 119A-N can be updated by using Reinforcement learning from human feedback (“RLHF”), for example, which is a self-learning machine learning (ML) technique used throughout generative artificial intelligence (e.g., generative AI) applications, including in large language models (LLM), for example, that uses human feedback to optimize ML models to self-learn more efficiently. Reinforcement learning (RL) techniques can train the IPSM 502 to make decisions that maximize rewards, making their outcomes more accurate. RLHF incorporates human feedback in the rewards function, so the IPSM 502 ML model can perform tasks more aligned with human goals, wants, and needs.

Variation in the IPSM process flow 600 shown in FIG. 6 are contemplated. In particular, the IPSM 502 can first check for a high-risk abnormal patterns, then check for a medium-risk abnormal patterns if a high-risk pattern is not found. Updating the set of normal activity patterns 119A-N after a medium risk warning pattern is proved normal is also contemplated.

In the examples above, the energy system 102, energy application 103, power conversion system 104, energy storage nodes 105A-N, control subsystem 110, control system 115, etc. can each include a processor. As used herein, a processor 312, 352 is a hardware circuit having elements structured and arranged to perform one or more processing functions, typically various data processing functions. Although discrete logic components could be used, the examples utilize components forming a programmable central processing unit (CPU). A processor 312, 352 for example includes or is part of one or more integrated circuit (IC) chips incorporating the electronic elements to perform the functions of the CPU. The processors 312, 352 for example, may be based on any known or available microprocessor architecture, such as a Reduced Instruction Set Computing (RISC) using an ARM architecture. Of course, other processor circuitry may be used to form the CPU or processor hardware in. The illustrated examples of the processors 312, 352 can include one microprocessor or a multi-processor architecture. A digital signal processor (DSP) or field-programmable gate array (FPGA) could be suitable replacements for the processors 312, 352, but may consume more power with added complexity.

The applicable processor 312, 352 executes programming or instructions to configure the energy system 102, energy application 103, power conversion system 104, energy storage nodes 105A-N, control subsystem 110, control system 115, etc. to perform various operations. For example, such operations may include various general operations (e.g., a clock function, recording and logging operational status and/or failure information) as well as various system-specific operations (e.g., daylighting and/or energy management) functions. Although a processor 312, 352 may be configured by use of hardwired logic, typical processors are general processing circuits configured by execution of programming, e.g., instructions and any associated setting data from the memories 313, 353 shown or from other included storage media and/or received from remote storage media.

In the examples above, the energy system 102, energy application 103, power conversion system 104, energy storage nodes 105A-N, control subsystem 110, control system 115, etc. each include a memory. The memory 313, 353 may include a flash memory (non-volatile or persistent storage), a read-only memory (ROM), and a random access memory (RAM) (volatile storage). The RAM serves as short term storage for instructions and data being handled by the processors 312, 352 e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

Hence, a machine-readable medium or a computer-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

According to exemplary embodiments of the present disclosure the one or more processors and control circuits can include one or more of any known general purpose processor or integrated circuit such as a central processing unit (CPU), microprocessor, field programmable gate array (FPGA), Application Specific Integrated Circuit (ASIC), Digital Signal Processor (DSP), or other suitable programmable processing or computing device or circuit as desired that is specially programmed to perform operations for achieving the results of the exemplar embodiments described herein. The processor(s) can be configured to include and perform features of the exemplary embodiments of the present disclosure, such as the intelligent protection shield module (“IPSM”) control programming 330A-B. The features can be performed through program code encoded or recorded on the processor(s), or stored in a non-volatile memory device, such as Read-Only Memory (ROM), erasable programmable read-only memory (EPROM), or other suitable memory device or circuit as desired. Accordingly, such computer programs can represent controllers of the computing device.

In another exemplary embodiment, the program code, such as the battery condition aware control protocol 400 and the intelligent protection shield module (“IPSM”) control programming 330A-B, can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

The one or more processors 312, 352 can be included in a computing system that is configured with components such as memory, a hard drive, an input/output (I/O) interface, a communication interface, a display and any other suitable component as desired. The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, or any other suitable network communication interface as desired. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, or any other suitable communication link as desired.

Where the present disclosure is implemented using programming or software, including but not limited to the intelligent protection shield module (“IPSM”) module control programming 330A, for example, the programming or software can be stored in a computer program product or non-transitory computer readable medium and loaded into the computing device using a removable storage drive or communications interface. In an exemplary embodiment, any computing device, such as control system 115 and control subsystem 110, disclosed herein can also include a display interface that outputs display signals to a display unit, e.g., LCD screen, plasma screen, LED screen, DLP screen, CRT screen, or any other suitable graphical interface as desired.

It will be understood that the terms and expressions used herein have the ordinary meaning as is accorded to such terms and expressions with respect to their corresponding respective areas of inquiry and study except where specific meanings have otherwise been set forth herein. Relational terms such as first and second, or evident and alternative, and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” and “substantially” mean that the parameter value or the like varies up to ±10% from the stated amount or position.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

What is claimed is:

1. A system, comprising:
an energy storage system, including:
at least one power conversion system coupled to a plurality of energy storage elements;
at least one control system coupled to the plurality of energy storage elements and the at least one power conversion system; and
an intelligent protection shield module (“IPSM”) coupled to the energy storage system and comprising a processor, the IPSM being configured to:
detect abnormalities when observed patterns match any abnormal activity patterns or when governing logics of the energy storage system are violated; and
execute containment of the energy storage system when abnormalities are detected.

2. The system of claim 1, wherein the IPSM is further configured to:
monitor control signals of the energy storage system;
observe activity patterns of the energy storage system; and
determine, based on the monitored control signals and the observed activity patterns, whether the observed patterns match any abnormal activity patterns or if governing logics of the energy storage system are violated.

3. The system of claim 1, wherein the processor is configured to execute a machine learning algorithm.

4. The system of claim 1, wherein the IPSM is further configured to be trained with a set of normal activity patterns by analyzing existing routine operating states of the energy storage system and trained with a set of abnormal activities through simulated harmful scenarios.

5. The system of claim 1, wherein the governing logics are derived from physics, architecture, and power flow of the energy storage system.

6. The system of claim 1, wherein the at least one power conversion system is configured to standardize power inputs and outputs to and from the plurality of energy storage elements, wherein at least one governing logic is calculated based on an equation:
$${\sum }_{i}^{n} {P}_{i} \geq {P}_{PIC} \geq {\sum }_{i}^{n} α {P}_{i} , 0 < α < 1$$
wherein P_{PIC} is an electrical power output at a point of interconnection of the energy storage system with an electrical application, Pᵢ is an output power of the at least one power conversion system, i is a number associated with each corresponding power conversion system of the at least one power conversion system, n is a summation index that indicates a number of power conversion systems in the energy storage system, and α is a coefficient that adjusts for losses in the energy storage system.

7. The system of claim 6, wherein α=0.9 indicates an expected maximum of 10% energy loss in the energy storage system.

8. The system of claim 6, wherein if the electrical power output at the point of interconnection of the energy storage system with the electrical application does not match a sum of electrical power outputs of the at least one power conversion system and an electrical power loss, then the IPSM is further configured to determine that a power flow law is violated and there is an abnormality.

9. The system of claim 1, wherein the IPSM is further configured to control containment of the energy storage system by determining a risk level of the detected abnormalities.

10. The system of claim 9, wherein when the IPSM determines a high risk level of the detected abnormalities, the IPSM reports high-risks.

11. The system of claim 10, wherein when the IPSM determines the high risk level of the detected abnormalities, the IPSM is configured to stop control commands.

12. The system of claim 10, wherein after the high-risks are investigated and the observed patterns are proved normal, the IPSM is further configured to update a set of normal activity patterns by adding the observed patterns.

13. The system of claim 8, wherein after the high-risks are investigated and the observed patterns are proved normal, the IPSM is further configured to use Reinforcement learning from human feedback (“RLHF”) to update a set of normal activity patterns by adding the observed patterns.

14. The system of claim 1, further comprising a performance monitoring system configured to communicate with, and control, the plurality of energy storage elements, wherein the performance monitoring system is configured to interface with, or includes, the IPSM.

15. A method, comprising:
detecting abnormalities of an energy storage system when observed patterns of the energy storage system match any abnormal activity patterns or when governing logics of the energy storage system are violated; and
executing containment of the energy storage system when abnormalities are detected.

16. The method of claim 15, further comprising training an intelligent protection shield module (“IPSM”) with a set of normal activity patterns by analyzing existing routine operating states of the energy storage system and training a set of abnormal activities through simulated harmful scenarios.

17. The method of claim 15, further comprising deriving the governing logics from physics, architecture, and power flow of the energy storage system.

18. The method of claim 15, further comprising:
coupling at least one power conversion system to a plurality of energy storage elements; and
calculating at least one governing logic based on an equation:
$${\sum }_{i}^{n} {P}_{i} \geq {P}_{PIC} \geq {\sum }_{i}^{n} α {P}_{i} , 0 < α < 1$$
wherein P_{PIC} is an electrical power output at a point of interconnection of the energy storage system with an electrical application, Pᵢ is an output power of the at least one power conversion system, i is a number associated with each corresponding power conversion system of the at least one power conversion system, n is a summation index that indicates a number of power conversion systems in the energy storage system, and α is a coefficient that adjusts for losses in the energy storage system.

19. The method of claim 18, further comprising determining that a power flow law is violated and there is an abnormality if the electrical power output at the point of interconnection of the energy storage system with the electrical application does not match a sum of electrical power outputs of the at least one power conversion system and an electrical power loss.

20. A non-transitory computer-readable medium, comprising an intelligent protection shield module (“IPSM”), wherein execution of the IPSM by one or more processors configures one or more computing devices to:
detect abnormalities when observed patterns of an energy storage system match any abnormal activity patterns or when governing logics of the energy storage system are violated; and
execute containment of the energy storage system when abnormalities are detected.
